(19) United States
(12) Patent Application Publication
(10) Pub. No.: US 2018/0024276 A1
(43) Pub. Date: Jan. 25, 2018

(54) OPTICAL ELEMENTS WITH STRESS-BALANCING COATINGS

(71) Applicant: Corning Incorporated, Corning, NY (US)

(72) Inventor: Jue Wang, Fairport, NY (US)

(21) Appl. No.: 15/646,883

(22) Filed: Jul. 11, 2017

Related U.S. Application Data
(60) Provisional application No. 62/365,066, filed on Jul. 21, 2016.

(51) Int. Cl. G02B 1/14; G02B 1/11; G02B 27/14

(52) U.S. Cl. CPC G02B 1/14; G02B 27/142; G02B 1/11

(57) ABSTRACT

Optical elements with coatings having low surface figure are described. The optical element includes coatings on two or more surfaces. At least one of the coatings includes a stress-compensating layer. In the absence of the stress-compensating layer, the coatings are mismatched in stress. The difference in stress increases surface figure and distorts the wavefront of optical signals that are reflected and/or transmitted through the optical element. The stress-compensating layer acts to reduce mismatch in stress and leads to coatings with reduced surface figure and reduced distortion of wavefronts.

This application claims the benefit of priority under 35 U.S.C. §119 of U.S. Provisional Application Ser. No. 62/365,066 filed on Jul. 21, 2016 the content of which is relied upon and incorporated herein by reference in its entirety.

### FIELD

This description pertains to coated optical elements. More particularly, this description pertains to coated optical elements having low surface figure. Most particularly, this description pertains to optical elements having two or more coatings, where stresses in the coatings are balanced to provide coating surfaces with high flatness and low figure.

### BACKGROUND

Many applications in precision optics and laser optics require optical elements with multilayer coatings. Representative optical elements include beam splitters, anti-reflection optics, quarter-wave plates, and bandpass filters. To achieve consistent performance and to meet increasingly stringent performance specifications, it is essential that multilayer coatings exhibit low loss, high durability, and minimum surface distortions.

Multilayer coatings include two or more layers made from different materials. Many multilayer coatings, for example, include an alternating sequence of a layer of a higher index material and a layer of a lower index material. Common materials used in multilayer coatings include metal oxides, metal fluorides, SiO₂, and F-doped SiO₂.

One of the problems associated with coatings for optical elements is stress. The materials or combination of materials used to form multilayer coatings are typically in compressive or tensile stress. Stress arises due to factors such as lattice mismatch with the substrate, defects, non-uniformities in composition, impurities, method of deposition, and thermal history of the layers in the coating, as well as the CTE (coefficient of thermal expansion) mismatch between the substrates and coatings. Coating stress is undesirable because it leads to deformation in the surface of the optical element that cause distortions in the wavefront of optical beams that are transmitted or reflected by the optical element. There is a need for optical elements with multilayer coatings that exhibit little or no surface deformation.

### SUMMARY

Optical elements with coatings having low surface figure are described. Low surface figure is achieved through a balancing of coating stresses. The optical element includes coatings on two or more surfaces. At least one of the coatings includes a stress-compensating layer. In the absence of the stress-compensating layer, the coatings are mismatched in stress. The difference in stress increases surface figure and distorts the wavefront of optical signals that are reflected from and/or transmitted through the optical element. The stress-compensating layer acts to reduce mismatch in stress and leads to coatings with reduced surface figure and reduced distortion of wavefronts.

In one embodiment, the optical element includes two coatings on two surfaces of a substrate. The two surfaces are adjacent or opposing and may be parallel. The coatings may be single layer coatings or multiple layer coatings. Each coating includes at least one layer having the same composition as a layer in the other coating, where the layers of the same composition differ in stress or density. By adjusting the relative stresses or relative densities of the layers of the same composition, the total stress of the two coatings can be balanced. The stress in one coating, for example, can be adjusted to balance the stress in another coating. The net result is stress-balanced coatings that feature a reduction in surface figure and a reduction in wavefront distortion of the optical element.

Suitable materials for layers of the coatings include SiO₂, metal oxides, and metal fluorides. In one embodiment, the layers are formed by plasma ion assisted deposition, where layer stress or layer density can be adjusted by varying deposition conditions to control the amount of momentum transferred per atom to the layer during deposition.

The present disclosure extends to:

An optical element comprising:

a substrate, said substrate having a first surface and a second surface;

a first coating on said first surface, said first coating having a first coating stress and including a first layer, said first layer comprising a first material, said first material having a first layer stress in said first layer;

a second coating on said second surface, said second coating having a second coating stress and including a second layer, said second layer comprising said first material, said first material having a second layer stress in said second layer, said second layer stress being greater in magnitude than said first layer stress.

The present disclosure extends to:

An optical element comprising:

a substrate, said substrate having a first surface and a second surface;

a first coating on said first surface, said first coating including a first layer, said first layer comprising a first material, said first material having a first density in said first layer;

a second coating on said second surface, said second coating including a second layer, said second layer comprising said first material, said first material having a second density in said second layer, said second density being greater than said first density.

The present disclosure extends to:

A method of forming an optical element comprising:

forming a first coating on a first surface of a substrate, said first coating having a first coating stress and including a first layer, said first layer including a first material, said first material having a first layer stress in said first layer; and

forming a second coating on a second surface of said substrate, said second coating having a second coating stress and including a second layer, said second layer including said first material, said first material having a second layer stress in said second layer, said second layer stress being greater than said first layer stress.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 depicts an optical element having a beam splitting coating and an antireflection coating on opposing surfaces of a substrate;

FIG. 2 shows the calculated wavelength dependence of the reflectance and transmittance of the beam splitting coating of the optical element shown in FIG. 1 for an angle of incidence of 45°.

FIG. 3 shows the calculated wavelength dependence of the reflectance and transmittance of the antireflection coating of the optical element shown in FIG. 1 for an angle of incidence of 45°.

FIG. 4 depicts a system for PIAD deposition of thin film materials;

FIG. 5 shows an image of a surface of a fused silica substrate;

FIG. 6 shows an image of a surface of a beam splitting coating on a fused silica substrate;

FIG. 7 shows compressive stress as a function of momentum transferred per atom for SiO₂ layers of three thicknesses.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are components (including materials, compounds, compositions, and method steps) that can be used for, in conjunction with, in preparation for, or as embodiments of the disclosed reflecting optical elements and methods for making reflecting optical elements. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. Similarly, if components D, E, and F are individually disclosed, then each combination D-E, E-F, D-F, and D-E-F is also disclosed. This concept applies to all aspects of this disclosure including, but not limited to, components corresponding to materials, compounds, compositions, and steps in methods.

In this specification and in the claims which follow, reference will be made to a number of terms which shall be defined to have the following meanings:

“Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

“Contact” refers to direct contact or indirect contact. Direct contact refers to contact in the absence of an intervening material and indirect contact refers to contact through one or more intervening materials. Elements in direct contact touch each other. Elements in indirect contact do not touch each other, but do touch an intervening material or series of intervening materials extending from one element to the other, where each element touches the intervening material or at least one of the series of intervening materials. Elements in contact may be rigidly or non-rigidly joined. Contacting refers to placing two elements in direct or indirect contact. Elements in direct (indirect) contact may be said to directly (indirectly) contact each other.

“On” refers to a relationship in which a layer is in contact with and overlies another layer. If, for example, an optical element includes a substrate, a layer A in direct contact with the substrate, and a layer B in direct contact with layer A and indirect contact with the substrate, layers A and B may be said to be on the substrate and layer B may be said to be on layer A. Layer A, however, cannot be said to be on layer B.

“Surface figure” refers to the shape of a surface, including irregularity and power. Irregularity is asymmetric. Power is symmetric and corresponds to a concave or a convex shape. Irregularity is dominated by surface finishing, while power is impacted by coating stress.

“Power” refers to deviations in the surface of an optical element from a planar configuration. Representative deviations from planarity include curvatures that produce concave or convex features in the surface. The concave or convex features may extend over the entire surface or over portions of the surface.

A surface of an optical element corresponds to an outer boundary of the optical element. An optical element may have more than one surface. Different surfaces are separated by an edge, vertex, or other surface discontinuity. By way of example, a cube has six surfaces (each face is a surface) and a cylinder has three surfaces (top surface, bottom surface, and intermediate round surface). Where the substrate is uncoated, surface refers to the surface of the substrate. Where the substrate is coated, surface refers to the surface of the coating. If the coating is a multilayer coating, surface refers to the layer furthest removed from the substrate. Whether coated or uncoated, a surface of the substrate may be referred to as a substrate surface. The surface of a coating may be referred to as a coating surface. Adjacent surfaces are surfaces that share an edge, vertex or other surface discontinuity. Opposing surfaces are surfaces that do not share an edge, vertex, or other surface discontinuity. Opposing surfaces may be parallel. By way of example, the top and bottom surfaces of a cylinder are opposing, while the top and intermediate rounded surfaces of a cylinder are adjacent.

“Coating” refers to a sequence of one or more layers formed on a surface of a substrate. Ordering of layers in a coating will be described relative to the substrate. Description of the ordering of the layers herein is irrespective of the orientation of the substrate. The substrate forms the base of the optical element. Layers in contact with the substrate are said to “overlie” the substrate. When two or more layers are formed on the substrate, a first layer is said to overlie a second layer if the first layer is further from the substrate than the second layer. If a first layer overlies a second layer, the second layer may be said to “underlie” the first layer. Layers that underlie or overlie each other may be in direct or indirect contact with each other. If, for example, an optical element includes a substrate, a layer A in direct contact with the substrate, a layer B in direct contact with layer A and indirect contact with the substrate, and a layer C in direct contact with layer B and indirect contact with layer A and the substrate, each of layers A, B, and C may be said to overlie the substrate. Layer A may be said to underlie layers B and C. Layer B may be said to overlie layer A and underlie layer C. Layer C may be said to overlie layers A and B. Layers A and B may be said to be between the substrate and layer C. Layer B may be said to be between layers A and C.

“Coating stress” refers to the net stress of all layers present in a coating. “Layer stress” refers to the stress in an individual layer of a coating. If a coating consists solely of a single layer, coating stress and layer stress are equal.

Unless otherwise specified, surface figure is determined by interferometry and is expressed in terms of the number of fringes based on a wavelength of 632.8 nm. The measurement wavelength for interferometry may be 632.8 nm or another wavelength. If a wavelength other than 632.8 nm is used, the measured number of fringes is converted to the corresponding number of fringes at 632.8 nm. Low (lower) surface figure refers to a surface having a low (lower) number of fringes and high (higher) surface figure refers to a surface having a high (higher) number of fringes. Lower figure corresponds to a smaller deviation from planarity and higher figure corresponds to a larger deviation from planarity.

“Stress-compensating layer” refers to a layer that is included in a coating to modify the stress of the coating. A stress-compensating layer in a coating on one surface of the substrate acts to offset (completely or partially) the difference between the stress in the coating and the stress in another coating on another surface of the substrate. The difference between the stress of coatings on two surfaces of the substrate is greater without inclusion of the stress-compensating layer than with inclusion of the stress-compensating layer.

Reference will now be made in detail to illustrative embodiments of the present description.

The present description provides optical elements having a low surface figure. The optical elements include substrate and coatings on two or more substrate surfaces. The coatings are optical coatings designed to enhance the functionality of the optical element. Embodiments include beam splitting coatings and antireflection coatings. Coatings with different optical functionality may be placed on different surfaces of the substrate. The different surfaces of the substrate may be adjacent or opposing.

The optical element includes two or more coatings, each of which is in compressive or tensile stress. The coatings are designed, however, so that the effect of the stress of one coating on the figure of a surface of the optical element is balanced by the stress of one or more other coatings to provide a net reduction in the figure of the surface.

Compositions for layers in the present coatings include oxides, such as SiO₂ or metal oxides, and fluorides, such as metal fluorides. Metal oxides include transition metal oxides and rare earth oxides. Metal fluorides include transition metal fluorides and rare earth fluorides. Representative layer compositions include SiO₂, Ta₂O₅, TiO₂, Nb₂O₅, HfO₂, Yb₂O₃, Al₂O₃, AlF₃, GdF₃, LaF₃, YF₃, YbF₃, and MgF₂.

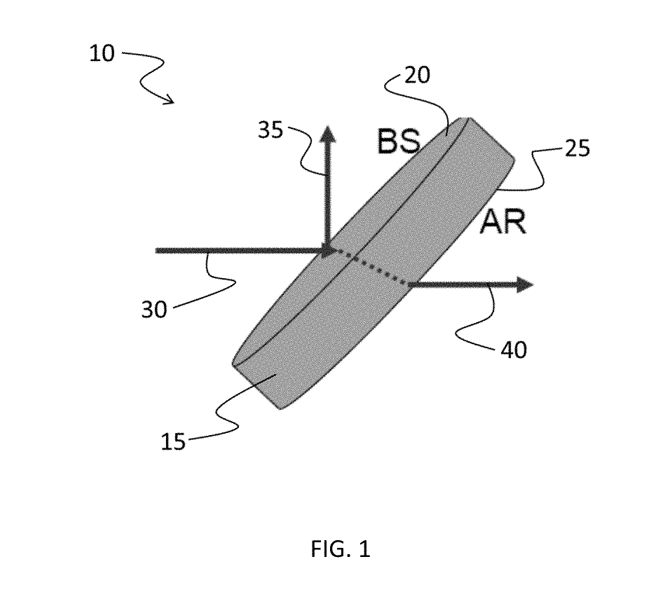

FIG. 1 depicts an optical element having coatings on two opposing surfaces. Optical element 10 is a beam splitter that includes substrate 15, front surface 20 and back surface 25. Front surface 20 and back surface 25 are opposing surfaces of substrate 15. Substrate 15 is high purity fused silica (HPFS). Front surface 20 includes a beam splitting coating BS and back surface 25 includes an antireflection coating AR. Incident light 30 impinges on front surface 20 at an angle of 45° and is partially reflected and partially transmitted to provide reflected light 35 and transmitted light 40.

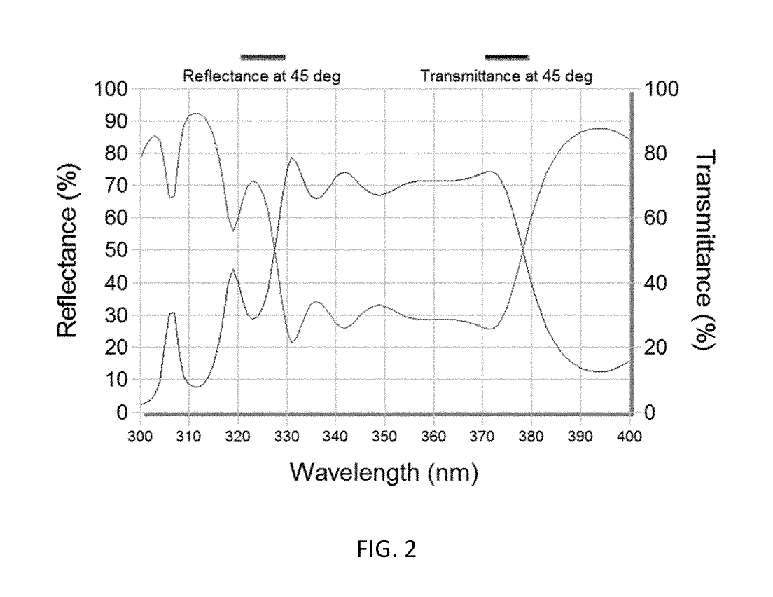

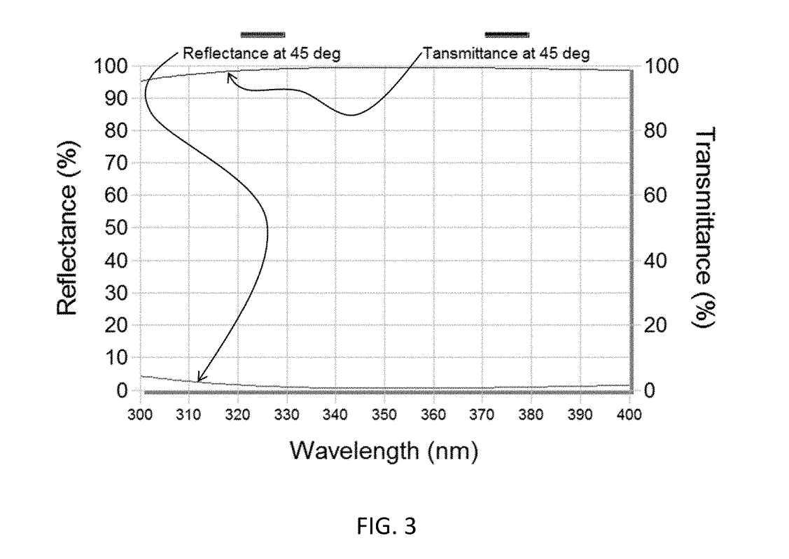

Beam splitting coating BS includes 22 periods of the combination Ta₂O₅/SiO₂. In the first period, a Ta₂O₅ layer is deposited on substrate 15 and an SiO₂ layer is formed on the Ta₂O₅ layer. The two-layer period is repeated to form a stack of 22 periods. In each period, the thickness of the Ta₂O₅ layer is 36.4 nm and the thickness of the SiO₂ layer is 54.5 nm. The total thickness of beam splitting coating BS is 2000 nm. Antireflection coating AR is a two-layer stack that includes a 9 nm thick layer of Ta₂O₅ in direct contact with substrate 15 and a 97 nm thick layer of MgF₂ formed on the 9 nm thick layer of Ta₂O₅. FIG. 2 shows the calculated wavelength dependence of the reflectance and transmission of the beam splitting coating BS at an angle of incidence of 45°. The results indicate a split ratio of 30/70 (30% reflectance, 70% transmission) over a wavelength range extending from about 335 nm to 365 nm. FIG. 3 shows the calculated wavelength dependence of the reflectance and transmission of the antireflection coating AR at an angle of incidence of 45°.

The MgF₂ layer of antireflection coating AR was prepared by thermal evaporation either through a thermal boat or electron beam evaporation of MgF₂ source material. The substrate temperature was 240° C.

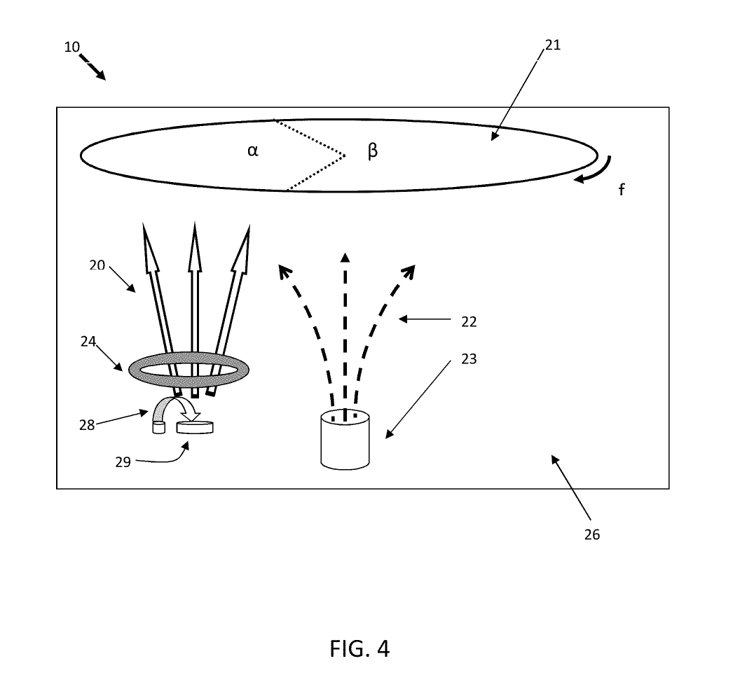

The Ta₂O₅ and SiO₂ layers of beam splitting coating BS and antireflection coating AR were deposited using the PIAD (plasma-ion-assisted deposition) technique. FIG. 4 illustrates a PIAD deposition apparatus 10 having a vacuum chamber 26 in which is located a substrate 21, an e-beam 28 that impinges a target 29 to produce a vapor flux 20 that passes through a central opening of reversed mask 24 for deposition on the substrate 21. Instead of a reversed mask, a partial mask may be used. In addition, apparatus 10 includes plasma source 23 that generates plasma 22. Ions from plasma 22 are directed to substrate 21.

Zones α and β of substrate 21 define regions that differ in the mechanism of plasma ion interaction with the material formed on substrate 21. The opening in reversed mask 24 acts as an aperture that restricts the angular distribution of vapor flux 20 produced upon evaporation of material from target 29 by e-beam 28. The restricted angular distribution of vapor flux 20 limits the area of coverage of vapor flux 20 on substrate 21. Zone α corresponds to the region of substrate 21 impinged by vapor flux 20. Zone β is the region of substrate 21 outside of the region impinged by vapor flux 20. Coverage of substrate 21 by vapor flux 20 is limited to zone α. As a result, deposition of material occurs in zone α, but not in zone β. Coverage of substrate 21 by plasma 22, in contrast, extends over zone α and zone β. As material is deposited in zone α, it is bombarded with plasma ions. The plasma ions transfer momentum to the deposited material and lead to a compact, dense layer of material. No deposition of material occurs in zone β, but previously deposited material is continually exposed to plasma ions. Momentum transferred from plasma ions to previously deposited material in zone β resulting in a smoothing of the surface of the previously deposited material. Substrate 21 rotates at frequency f to provide uniformity in density and smoothness of the deposited material across the surface of substrate 21. Representation rotational frequencies fare in the range from 4 rpm-20 rpm, or in the range from 8 rpm-18 rpm, or in the range from 12 rpm-15 rpm for deposition rates in the range from 0.1 nm/sec-10.0 nm/sec, or in the range from 0.3 nm/sec-5.0 nm/sec, or in the range from 0.7 nm/sec-2.0 nm/sec.

The overall coating processes can be described by the momentum transfer per deposited atom P as the sum of momentum transfer P_{α} in zone α and momentum transfer P_{β} in zone β in unit of (a.u. eV)^{0.5} during the coating process as shown by Equation (1)

$$P = {P}_{α} + {P}_{β} = \frac{1}{2 π} ( \frac{α}{R} κ + \frac{β}{{n}_{s} f} ) {J}_{i} \sqrt{2 {m}_{i} {eV}_{b}} \qquad ( 1 )$$

where V_{b} is the bias voltage (in units of volts), Jᵢ is the plasma ion flux (in units of ion/(cm² sec), mᵢ is the plasma ion mass (in atomic units (a.u.), R is the deposition rate (in units of nm/sec); e is the electron charge; k is a unit conversion factor; nₛ is the surface atom density of the deposited material (in units of atom/cm²); and α and β are the sizes of zone α and zone β (in units of radians measured relative to the center of the substrate), respectively. The bias voltage corresponds to the voltage applied between the plasma source and the surface of the substrate upon which deposition occurs. The substrate surface is typically at ground voltage. For purposes of this description, an Ar plasma was used and the plasma ion mass mᵢ corresponds to the mass of Ar⁺. Further information on the PIAD deposition technique can be found in U.S. Pat. Nos. 7,683,450; 8,153,241; and 8,399,110; the disclosures of which are hereby incorporated by reference.

As exemplified by FIGS. 2 and 3, calculations of the reflectance and transmission characteristics for coatings having a particular sequence of layers of specified thickness, ordering, numerosity, and composition are valuable in the design of optical elements. Design is greatly facilitated by accurate and reliable calculations of optical properties of coatings. Accuracy of calculation, however, depends on the assumptions used in the calculations. Most calculations of optical properties assume that the layers of coatings are planar. Deviations from planarity lead to distortions in wavefronts that compromise the accuracy of calculations.

In actual practice, stresses develop in the materials used to form the layers of coatings in optical elements. Contributions to coating stress may include lattice mismatch of the coating with the substrate or of layers within a coating with each other, defects in layers or at interfaces between layers, non-uniformities in the composition or structure of layers, impurities, grain boundaries and other microstructural features, method of deposition, processing conditions, and thermal history of the layers.

Coating stress is problematic in optical design because it often leads to deviations of substrates and coatings from planarity. The deviations lead to optical elements having non-planar surfaces. Non-planar surfaces have optical power and may be referred to as powered surfaces. Coating stress can be tensile or compressive. Tensile coating stress leads to concave surfaces and compressive coating stress leads to convex surfaces. Convex surfaces have positive power and concave surfaces have negative power.

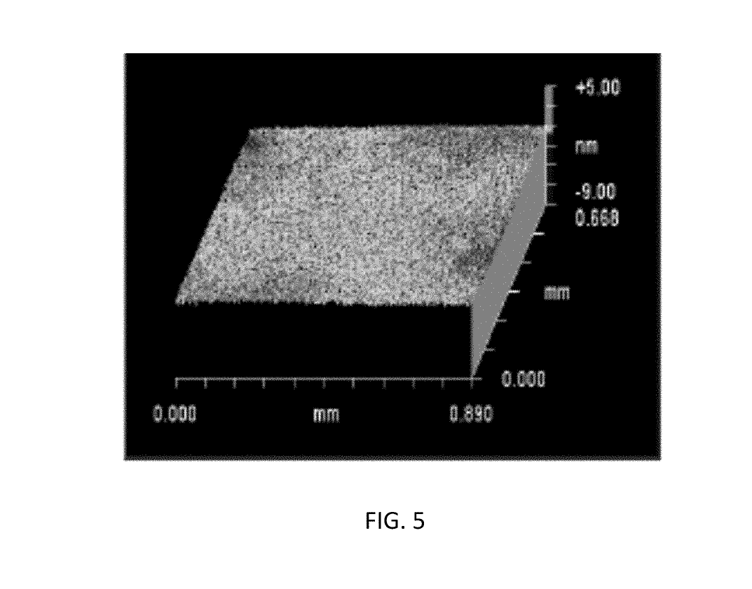

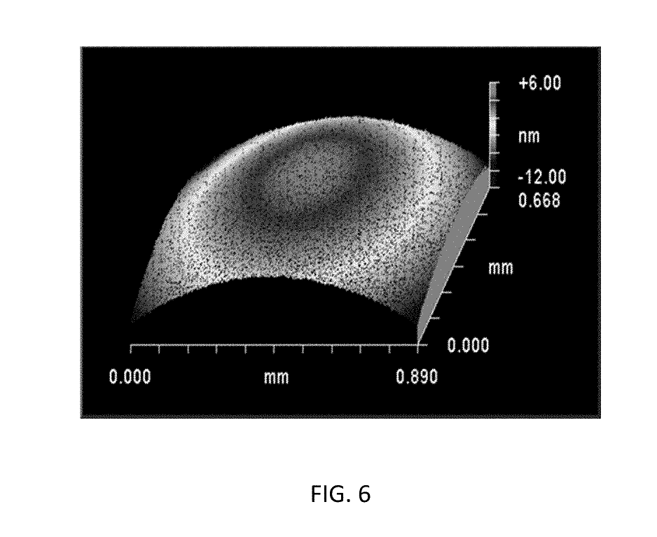

FIG. 5 shows an image of an uncoated high purity fused silica substrate. The image indicates that the surface of the uncoated substrate is highly planar with essentially no power contribution to surface figure. FIG. 6 shows an image of an optical element after deposition of coatings on opposing surfaces of the substrate. The optical element shown in FIG. 6 corresponds to the optical element depicted in FIG. 1. The optical element includes the substrate of FIG. 5 with beam splitting coating BS and antireflection coating AR on opposing surfaces. Beam splitting coating BS and antireflection coating AR are as described hereinabove for the optical element shown in FIG. 1 and are present on the front surface and back surface of the substrate, respectively. The surface shown in FIG. 6 is the surface of beam splitting coating BS. Significant deviation of the surface from planarity is observed in FIG. 6.

The convex surface is a consequence of coating stresses. Coating stresses lead to a bending of the substrate and development of the convex surface. The convex surface produced by the coating stresses introduces distortions in the wavefront of light reflected or transmitted by the optical element and makes it difficult to accurately calculate optical properties.

In the design of the optical element depicted in FIGS. 1 and 6, no consideration was given to coating stress. Coatings were selected based on calculated optical properties based on planar layers designed to achieve desired performance. As is evident from FIG. 6, selection of layers and coatings based on calculated optical properties is insufficient because of surface distortions caused by coating stresses.

The present description provides a strategy for correcting distortions and reducing the figure of surfaces of optical elements. Stresses generally develop in coatings formed on any surface of an optical substrate. In the optical element depicted in FIGS. 1 and 6, for example, stresses are present in both beam splitting coating BS and antireflection coating AR. The present description recognizes that stresses will develop in coatings, but seeks to counteract the effect of coating stress on surface figure by balancing stresses from coatings formed on different surfaces of the substrate. Through management of stress in coatings formed on different surfaces, it becomes possible to counteract or correct non-planar deviations in surface figure to minimize distortions in the wavefront of light that is reflected or transmitted through an optical element.

Layer stress can be determined by measuring surface figure before and after coating the substrate. A modified form of Stoney's equation can be used to calculate the stress σₛ of an individual layer having thickness d_{f} on a substrate of thickness dₛ having Young's modulus Eₛ and Poisson's ratio νₛ:

$${σ}_{s} = \frac{2 {E}_{s}}{3 ( 1 - {v}_{s} )} {( \frac{{d}_{s}}{D} )}^{2} \frac{λ}{{d}_{f}} Δ f \qquad ( 2 )$$

where λ is the wavelength used for measurement of wavefront over a clear aperture having a diameter D and Δf is the difference in the number of fringes of the surface of the coating of a coated substrate and the number of fringes of the surface of the uncoated substrate measured at the wavelength λ. The number of fringes measured for a surface may be referred to as “fringe count” and correlates with surface figure. Δf is referred to as change in fringe count or change in surface figure. Δf accounts for the contribution of the layer to surface figure and factors out the initial figure of the substrate surface on which the coating is deposited. By convention, σₛ>0 corresponds to tensile stress and σₛ<0 corresponds to compressive stress. Since the maximum possible value of νₛ is 0.5, tensile stress occurs when Δf>0 and compressive stress occurs when Δf<0. Tensile stress leads to concave deformations in surface figure and compressive stress leads to convex deformations in surface figure.

Equation (2) applies when the substrate thickness dₛ is large compared to the layer thickness d_{f}. Knowledge of the material parameters for the layer and substrate permits determination of layer stress through measurements of fringe count before and after coating. To a good approximation, the stress of a multilayer coating is the sum of the stresses of the individual layers contained in the coating.

In accordance with the present description, layer stress can be controlled through conditions used in the deposition technique. For layers of a given composition, different levels of stress can be obtained by varying the deposition conditions. In one embodiment, the deposition technique is PIAD and stress is controlled by varying the momentum transfer during deposition. By adjusting the reversed mask shape and height, plasma conditions (e.g. bias voltage, plasma ion flux, plasma ion mass), sizes of zone α and zone β, and plate rotation frequency, one can control the amount of momentum transfer to atoms deposited on surfaces using the PIAD technique.

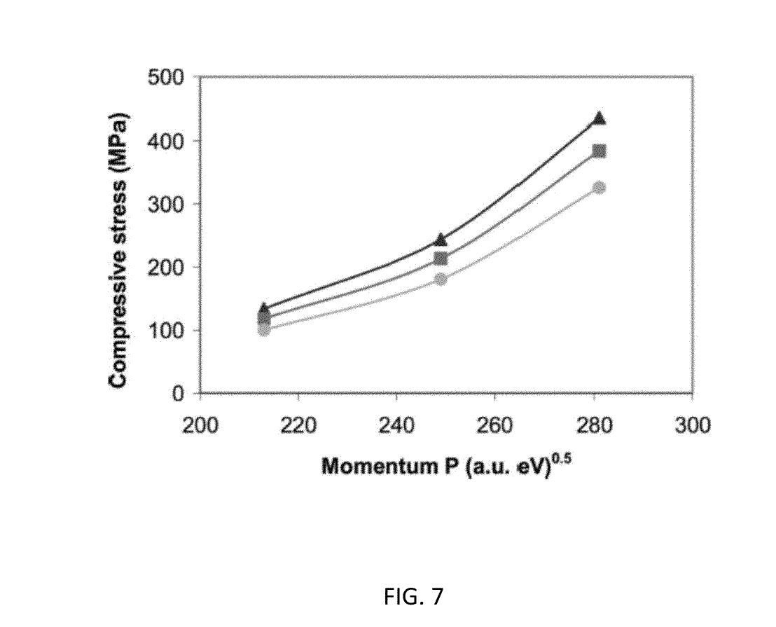

FIG. 7 shows the compressive stress of SiO₂ layers as a function of momentum transfer P per deposited atom for SiO₂ layers of thickness 100 nm (circles), 500 nm (squares), and 1000 nm (triangles). The momentum transfer P is given by Equation (1) and the conditions under which the data was obtained correspond to α=2π and β=0. The data indicate that the compressive stress can be varied over a wide range by controlling the momentum transfer P during PIAD deposition. Compressive stress increases with increasing momentum transfer. Analysis of the data indicates that compressive stress σ (in units of MPa) of the SiO₂ layers varies with momentum transfer according to the following empirical equation:

$$σ = \frac{1}{18} {d}^{\frac{1}{8}} {e}^{( \frac{P}{58} )} \qquad ( 3 )$$

where d is the thickness of the layer (in units of nm) and P is the momentum transfer per deposited atom (in units of (a.u. eV)^{0.5}).

While not wishing to be bound by theory, it is believed that higher compressive stresses occur at higher momentum transfer because higher momentum transfer leads to denser layers. Denser layers are believed to be more resistant to stress relaxation and retain a significant fraction of the internal stress that accompanies the deposition process. As momentum transfer decreases and layer density decreases, the structure of the layer is more open and accommodating to structural rearrangements conducive to relaxation of internal stress.

The present optical elements include coatings with one or more low-stress layers. The low-stress layers have low density relative to the fully densified form of the layer composition. For purposes of the present disclosure, the density of the fully densified form of SiO₂ corresponds to the density of SiO₂ produced by the PIAD technique at a value of momentum transfer P=280 (a.u. eV)^{0.5}), which density is expected to be about 2.2 g/cm³.

In one embodiment, the optical element includes a multilayer coating on one surface of a substrate, where the multilayer coating includes two layers having the same composition and where the two layers of the same composition differ in density. The multilayer coating may, for example, include two layers of SiO₂, where one layer of SiO₂ has a higher or lower density than another layer of SiO₂. Related embodiments encompass two or more layers of other compositions that differ in density within a multilayer coating.

In one embodiment, the optical element includes a multilayer coating on one surface of a substrate, where the multilayer coating includes two layers having the same composition and where the two layers of the same composition differ in layer stress. The multilayer coating may, for example, include two layers of SiO₂, where one layer of SiO₂ has a higher or lower compressive layer stress than another layer of SiO₂. Related embodiments encompass two or more layers of other compositions that differ in layer stress within a multilayer coating, where the layer stress is a compressive stress or a tensile stress.

In one embodiment, the optical element includes multilayer coatings on two surfaces of a substrate, where the multilayer coatings each include a layer having the same composition and where the two layers of the same composition differ in density. A multilayer coating on one substrate surface may, for example, include a layer of SiO₂ and a multilayer coating on another substrate surface may include a layer of SiO₂, where the layer of SiO₂ on one substrate surface has a higher or lower density than the layer of SiO₂ on the other substrate surface.

Related embodiments encompass layers of other compositions that differ in layer stress or density in coatings on different surfaces of the substrate. The different substrate surfaces may be adjacent or opposing. Coatings on different substrate surfaces may also include layers of two or more common compositions that differ in layer stress or density. A multilayer coating on one substrate surface may, for example, include a layer of SiO₂ and a layer of Ta₂O₅ and a multilayer coating on another substrate surface may include a layer of SiO₂ and a layer of Ta₂O₅, where the layer of SiO₂ on one substrate surface has a higher or lower layer stress and/or a higher or lower density than the layer of SiO₂ on the other substrate surface and the layer of Ta₂O₅ on one substrate surface has a higher or lower layer stress and/or a higher or lower density than the layer of Ta₂O₅ on the other substrate surface.

In one embodiment, the optical element includes multilayer coatings on two surfaces of a substrate, where the multilayer coatings each include a layer having the same composition and where the two layers of the same composition differ in layer stress. A multilayer coating on one substrate surface may, for example, include a layer of SiO₂ and a multilayer coating on another substrate surface may include a layer of SiO₂, where the layer of SiO₂ on one substrate surface has a higher compressive stress than the layer of SiO₂ on the other substrate surface. Related embodiments encompass layers of other compositions that differ in layer stress in coatings on different surfaces of the substrate. The different substrate surfaces may be adjacent or opposing and the stress may be compressive or tensile. Coatings on different substrate surfaces may also include layers of two or more common compositions that differ in layer stress. A multilayer coating on one substrate surface may, for example, include a layer of SiO₂ and a layer of Ta₂O₅ and a multilayer coating on another substrate surface may include a layer of SiO₂ and a layer of Ta₂O₅, where the layer of SiO₂ on one substrate surface has a higher or lower compressive or tensile stress than the layer of SiO₂ on the other substrate surface and the layer of Ta₂O₅ on one substrate surface has a higher or lower compressive or tensile stress than the layer of Ta₂O₅ on the other substrate surface.

As noted above, coating stress was not a consideration in the design of the coatings for the optical element depicted in FIG. 6. The powered surface evident in FIG. 6 for the beam splitting coating leads to distortions of the wavefront of incident light. Wavefront distortion can be reduced by controlling the stress of one or more layers on one or more substrate surfaces of the optical element. In one embodiment, wavefront distortion is reduced through offsetting or compensating stresses of coatings disposed on two or more substrate surfaces. The offsetting or compensating stresses leads to a balancing of stresses that reduces surface figure and non-planar distortions of surface figure.

Compressive stress in a coating on one substrate surface can be balanced by a compressive stress on another surface of the substrate. Tensile stress in a coating on one substrate surface can be balanced by a tensile stress on another surface of the substrate. The two substrate surfaces can be adjacent or opposing and the balancing of stresses may be partial or complete. In the situation of complete balancing of stresses, the surface of the coating is planar and wavefront distortion is eliminated. The closer the approach to complete balancing of stresses is, the closer to planarity is the coating surface and the less distorted the wavefront is.

In embodiments, the compressive stress of a coating on one substrate surface is in the range from 75% to 125%, or in the range from 80% to 120%, or in the range from 85% to 115%, or in the range from 90% to 110%, or in the range from 95% to 105% of the compressive stress of a coating on another surface of the substrate. If, for example, the compressive stress of a coating on one substrate surface is 100 MPa, the compressive stress of a coating on another surface of the substrate is in the range from 75 MPa to 125 MPa, or in the range from 80 MPa to 120 MPa, or in the range from 85 MPa to 115 MPa, or in the range from 90 MPa to 110 MPa, or in the range from 95 MPa to 105 MPa.

In embodiments, the tensile stress of a coating on one substrate surface is in the range from 75% to 125%, or in the range from 80% to 120%, or in the range from 85% to 115%, or in the range from 90% to 110%, or in the range from 95% to 105% of the tensile stress of a coating on another surface of the substrate. If, for example, the tensile stress of a coating on one substrate surface is 100 MPa, the tensile stress of a coating on another substrate surface is in the range from 75 MPa to 125 MPa, or in the range from 80 MPa to 120 MPa, or in the range from 85 MPa to 115 MPa, or in the range from 90 MPa to 110 MPa, or in the range from 95 MPa to 105 MPa.

In embodiments, the compressive stress of a coating on one substrate surface is in the range from 75% to 125%, or in the range from 80% to 120%, or in the range from 85% to 115%, or in the range from 90% to 110%, or in the range from 95% to 105% of the compressive stress of a coating on an opposing substrate surface. If, for example, the compressive stress of a coating on one substrate surface is 100 MPa, the compressive stress of a coating on an opposing substrate surface is in the range from 75 MPa to 125 MPa, or in the range from 80 MPa to 120 MPa, or in the range from 85 MPa to 115 MPa, or in the range from 90 MPa to 110 MPa, or in the range from 95 MPa to 105 MPa. The opposing substrate surfaces may be parallel.

In embodiments, the tensile stress of a coating on one substrate surface is in the range from 75% to 125%, or in the range from 80% to 120%, or in the range from 85% to 115%, or in the range from 90% to 110%, or in the range from 95% to 105% of the tensile stress of a coating on an opposing substrate surface. If, for example, the tensile stress of a coating on one substrate surface is 100 MPa, the tensile stress of a coating on an opposing substrate surface is in the range from 75 MPa to 125 MPa, or in the range from 80 MPa to 120 MPa, or in the range from 85 MPa to 115 MPa, or in the range from 90 MPa to 110 MPa, or in the range from 95 MPa to 105 MPa. The opposing substrate surfaces may be parallel.

The fringe count at the surface of a coating can be reduced through a balancing of the stresses of coatings on different surfaces of the substrate. The fringe count at 632.8 nm at the surface of a coating may be less than 0.20, or less than 0.15, or less than 0.10, or less than 0.075, or less than 0.050, or less than 0.025. The fringe count at 632.8 nm at the surfaces of each of two or more coatings may be less than 0.20, or less than 0.15, or less than 0.10, or less than 0.075, or less than 0.050, or less than 0.025.

The stress-balancing concept can be illustrated with the following representative examples.

### Example 1

An optical element using a fused silica substrate with a beam splitting coating and an antireflection coating is described. The fused silica substrate (HPFS 7980 obtained from Corning, Inc.) was in the form of a slab having a length of 115 mm, a width of 66 mm, and a thickness of 8 mm. The fused silica substrate included a front surface and a back surface, where the front surface and back surface were parallel opposing surfaces. The beam splitting coating was formed on the front surface and the antireflection coating was formed on the back surface. The front surface and back surface were polished before depositing the coatings and the wavefront distortions of the front surface and back surface were measured after polishing and before depositing the coatings.

The beam splitting coating consisted of 23 periods of Ta₂O₅/SiO₂, where the Ta₂O₅ layer of the first period was deposited directly on the front surface of the fused silica substrate, the SiO₂ layer of the first period was deposited directly on the Ta₂O₅ layer, and alternating Ta₂O₅ and SiO₂ layers were deposited until a multilayer coating of 23 periods was formed. The thickness of Ta₂O₅ in each period was 58 nm and the thickness of SiO₂ in each period was 36.9 nm. The Ta₂O₅ and SiO₂ layers were deposited at 120° C. at rates of 0.17 nm/sec and 0.25 nm/sec, respectively, and at bias voltages of 115 V and 110 V, respectively, by the PIAD technique described hereinabove. Using Equation (2) above and the difference in fringe count before and after deposition, the stress in the Ta₂O₅ layers was determined to be 135 MPa (tensile) and the stress in the SiO₂ layers was determined to be 240 MPa (compressive).

The antireflection coating consisted of a 9 nm thick layer of Ta₂O₅ deposited directly on the back surface of the fused silica substrate and a 97 nm thick layer of MgF₂ was deposited directly on the 9 nm thick layer of Ta₂O₅. The Ta₂O₅ layer was deposited by the PIAD technique described hereinabove. The MgF₂ layer was deposited by the evaporation technique described hereinabove.

Surface figure of coatings was determined through measurements of fringe count. Fringe count was measured by using short coherent interferometry at 850 nm and normal angle of incidence. The measured fringe count at 850 nm was converted to an equivalent fringe count at 632.8 nm. The fringe counts reported herein are fringe counts at 632.8 nm. The short coherent interferometry enables one to separate the S1 and the S2 surfaces. Surface figure for a coating is reported as the change in fringe count Δf (defined above), where the change in fringe count is the difference in the fringe count of the surface of the coating and the fringe count of the uncoated substrate surface on which the coating is deposited.

Surface figure of two samples was measured. The first sample included the beam splitting coating on the front surface of the substrate without the antireflection coating on the back surface of the substrate. Separate fringe count measurements were made for the surface of the beam splitting coating and for the front surface of the substrate before deposition of the beam splitting coating. The change in fringe count (Δf) of the two measurements was found to be 0.8809 fringes and corresponded to the surface figure of the beam splitting coating.

The second sample included the antireflection coating on the back surface of the substrate without the beam splitting coating on the front surface of the substrate. Separate fringe count measurements were made for the surface of the antireflection coating and for the back surface of the substrate before deposition of the antireflection coating. The change in fringe count (Δf) of the two measurements was found to be −0.0145 fringes and corresponded to the surface figure of the antireflection coating.

The results indicate that the stress of the beam splitting coating is compressive and acts to impose a convex deformation on the surface of the beam splitting coating and the front surface of the substrate, while the stress of the antireflection coating is tensile and acts to impose a concave deformation on the surface of the antireflection coating and the back surface of the substrate. Since the front surface and back surface of the substrate are opposing, the concave deformation imposed on the antireflection coating and the back surface of the substrate by the antireflection coating reinforces the convex deformation imposed on the beam splitting coating and front surface of the substrate by the beam splitting coating.

Since the front surface and back surface of the substrate are parallel, an optical element that includes the beam splitting coating on the front surface and the antireflection coating on the back surface is predicted to exhibit a surface figure of 0.8954 fringes on the surface of the beam splitting coating, which corresponds to the difference in fringe count of the surface of the beam splitting coating on the front surface of the substrate with the antireflection coating on the back surface and the fringe count of the uncoated front surface of the substrate with no antireflection coating on the back surface. The large surface figure reflects a significant net compressive stress for the beam splitting coating that is expected to produce a highly convex surface for the beam splitting coating in the optical element. Similarly, the surface figure of the antireflection coating is predicted to be −0.8954 fringes, which reflects a net tensile stress and highly concave surface for the antireflection coating in the optical element.

In accordance with the present description, the convex surface deformation of the beam splitting coating can be reduced by balancing the stresses of the coatings situated on the front and back surfaces of the substrate. The ideal condition for stress balancing occurs when the stresses of the coatings on the front and back surfaces of the substrate are of the same type (i.e. both coatings have compressive or tensile stress) and of the same magnitude. The closer the ideal condition is approached, the more complete is the balancing of stresses and the lower the surface figure of the coatings is.

One way to reduce the surface figure of the beam splitting coating of the present example is to increase the compressive stress on the back surface of the substrate. In order to maintain proper performance as a beam splitter, the optical element needs to include the antireflection coating on the back surface. The back surface, however, can be modified to further include, in addition to the two antireflection layers, one or more stress-compensating layers that make the net stress of the coating on the back surface compressive. The thickness and/or composition of the stress-compensating layer(s) can be adjusted to increase the compressive stress on the back surface of the substrate to balance the compressive stress of the beam splitting coating on the front surface of the substrate. The one or more stress-compensating layers are formed directly on the back surface of the substrate and the antireflection coating is formed directly on the stress-compensating layer or, when two or more stress-compensating layers are included, directly on the stress-compensating layer furthest removed from the substrate. To maintain performance of the optical element as a beamsplitter, the stress-compensating layer(s) preferably have high transmittance at the intended wavelength(s) of operation of the optical element.

In one embodiment, optical performance is assured by selecting a stress-compensating layer of a coating on one surface of the substrate to have the same compensation as a layer in a coating on another surface of the substrate. In the present example, for example, a stress-compensating layer for the coating on the back surface of the substrate can have the composition of one of the layers of the beam splitting coating. Embodiments are not so limited and stress-compensating layers of any composition having compensating stress and optical characteristics consistent with the intended use of the optical element can be used.

In the present example, the beam splitting coating includes layers of SiO₂ and Ta₂O₅. Since SiO₂ is expected to have higher compressive stress than Ta₂O₅, it is preferably to include SiO₂ as a stress-compensating layer on the back surface of the substrate. The higher compressive stress of SiO₂ means that compensation of the stress of the beam splitting coating can be accomplished with a thinner SiO₂ layer. Thinner stress-compensating layers are preferred because they reduce process cost and time of manufacture.

Based on the difference in fringe count between the beam splitting coating and the antireflection coating in this example and using Equation (2), it is estimated that inclusion of an SiO₂ layer with a layer stress of 240 MPa and thickness of 1819 nm on the back surface of the substrate along with the antireflection coating would balance the stress between the front surface and back surface and minimize wavefront distortion in the optical element of this example. In a preferred configuration, the SiO₂ layer with layer stress of 240 MPa and thickness of 1819 nm is formed directly on the back surface of the substrate and the antireflection coating is formed directly on the SiO₂ layer with layer stress of 240 MPa and thickness of 1819 nm.

### Example 2

In accordance with the principles disclosed herein, a reduction of the layer stress of SiO₂ in the beam splitting coating permits a balancing of stresses between the front surface and back surface of the substrate using a thinner layer of SiO₂ in combination with the antireflection coating on the back surface of the substrate. As noted herein, the layer stress of SiO₂ can be reduced by reducing the momentum transfer P used in the PIAD process when depositing the SiO₂ layers of the beam splitting coating.

In this example, an optical element with beam splitting and antireflection coatings having the layer sequence, layer thickness, and layer composition described in EXAMPLE 1 is considered. The PIAD conditions, however, were adjusted to lower momentum transfer during deposition of the SiO₂ layers of the beam splitting coating to produce SiO₂ layers having a compressive stress of 200 MPa. All other aspects of the optical element were the same as described in EXAMPLE 1.

The surface figure of a sample with the beam splitting coating on the front surface of the substrate without the antireflection coating on the back surface of the substrate was determined. Fringe count measurements were made for the surface of the beam splitting coating and for the front surface of the substrate before deposition of the beam splitting coating. The change in fringe count (Δf) of the two measurements was found to be 0.7714 fringes and corresponded to the surface figure of the beam splitting coating. The reduction in fringe count of the beam splitting coating from 0.8809 (EXAMPLE 1) to 0.7714 (EXAMPLE 2) is a consequence of the lower layer stress for SiO₂ in the beam splitting coating of EXAMPLE 2.

The antireflection coating of the optical element of this example was the same as in EXAMPLE 1. The change in fringe count (Δf) for the antireflection coating was measured as in EXAMPLE 1 and was determined to be −0.0145 fringes.

The results indicate that the stress of the beam splitting coating is compressive and acts to impose a convex deformation on the surface of the beam splitting coating and the front surface of the substrate, while the stress of the antireflection coating is tensile and acts to impose a concave deformation on the surface of the antireflection coating and the back surface of the substrate. Since the front surface and back surface of the substrate are opposing, the concave deformation imposed on the antireflection coating and the back surface of the substrate by the antireflection coating reinforces the convex deformation imposed on the beam splitting coating and front surface of the substrate by the beam splitting coating.

Since the front surface and back surface of the substrate are parallel, an optical element that includes the beam splitting coating on the front surface and the antireflection coating on the back surface is predicted to exhibit a surface figure of 0.7859 fringes on the surface of the beam splitting coating, which corresponds to the difference in fringe count of the surface of the beam splitting coating on the front surface of the substrate with the antireflection coating on the back surface and the fringe count of the uncoated front surface of the substrate with no antireflection coating on the back surface. The surface figure reflects a net compressive stress for the beam splitting coating that is expected to produce a highly convex surface for the beam splitting coating in the optical element. Similarly, the surface figure of the antireflection coating is predicted to be −0.7859 fringes, which reflects a net tensile stress and highly concave surface for the antireflection coating in the optical element.

Based on the difference in fringe count between the beam splitting coating and the antireflection coating in this example and using Equation (2), it is estimated that inclusion of an SiO₂ layer with a layer stress of 240 MPa and thickness of 1597 nm on the back surface of the substrate along with the antireflection coating would balance the stress between the front surface and back surface and minimize wavefront distortion in the optical element of this example. In a preferred configuration, the SiO₂ layer with a layer stress of 240 MPa and thickness of 1597 nm is formed directly on the back surface of the substrate and the antireflection coating is formed directly on the SiO₂ layer with a layer stress of 240 MPa and thickness 1597 nm.

This example shows that for a given layer stress of the stress-balancing layer, the thickness of the stress-balancing layer on the antireflection side of the substrate can be reduced by reducing the layer stress of the beam splitting coating. In particular, the thickness of a stress-balancing SiO₂ layer with layer stress of 240 MPa was reduced from 1819 nm to 1597 nm by reducing the layer stress of SiO₂ in the beam splitting coating from 240 MPa (EXAMPLE 1) to 200 MPa (EXAMPLE 2). The reduced thickness required for the stress-balancing layer improves process efficiency and increases process speed during manufacture of stress-balanced optical elements.

### Example 3

In this example, an optical element similar to the optical elements of EXAMPLE 1 and EXAMPLE 2 is described. As in EXAMPLE 1 and EXAMPLE 2, the substrate was a fused silica substrate in the form of a slab having a length of 115 mm, a width of 66 mm, and a thickness of 8 mm. The fused silica substrate included a front surface and a back surface, where the front surface and back surface were parallel opposing surfaces. The beam splitting coating was formed on the front surface and the antireflection coating was formed on the back surface. The front surface and back surface were polished before depositing the coatings and the wavefront distortions of the front surface and back surface were measured after polishing and before depositing the coatings.

The beam splitting coating used in this example is a modified form of the beam splitting coating described in EXAMPLE 1 and EXAMPLE 2 in which each SiO₂ layer was replaced by a fluorine-doped SiO₂ layer and the number, thickness, and sequence of layers was otherwise unchanged. Doping of SiO₂ with fluorine is known to relax layer stress. The beam splitting coating of this example is thus expected to have lower surface figure than the beam splitting coatings of EXAMPLE 1 and EXAMPLE 2. The fluorine-doped SiO₂ layers were deposited using PIAD. The fluorine dopant concentration was 1.7 wt % and conditions were adjusted to produce fluorine-doped SiO₂ layers having a layer stress of 20 MPa. The number and thickness of the fluorine-doped SiO₂ layers in the beam splitting coating of this example was the same as the number and thickness of the SiO₂ layers in the beam splitting coatings described in EXAMPLE 1 and EXAMPLE 2. The number and thickness of the Ta₂O₅ layers in the beam splitting coating of this example was the same as the number and thickness of the Ta₂O₅ layers in the beam splitting coatings described in EXAMPLE 1 and EXAMPLE 2.

The surface figure of a sample with the beam splitting coating on the front surface of the substrate without the antireflection coating on the back surface of the substrate was determined. Fringe count measurements were made for the surface of the beam splitting coating and for the front surface of the substrate before deposition of the beam splitting coating. The change in fringe count (Δf) of the two measurements was found to be 0.2895 fringes and corresponded to the surface figure of the beam splitting coating. The reduction in fringe count of the beam splitting coating from 0.8809 (EXAMPLE 1) or 0.7714 (EXAMPLE 2) to 0.2786 (EXAMPLE 3) is a consequence of the lower layer stress for fluorine-doped SiO₂ in the beam splitting coating of EXAMPLE 3.

The antireflection coating of the optical element of this example was the same as in EXAMPLE 1. The change in fringe count (Δf) for the antireflection coating was measured as in EXAMPLE 1 and was determined to be −0.0145 fringes.

Since the front surface and back surface of the substrate are parallel, an optical element that includes the beam splitting coating on the front surface and the antireflection coating on the back surface is predicted to exhibit a surface figure of 0.2931 fringes on the surface of the beam splitting coating, which corresponds to the difference in fringe count of the surface of the beam splitting coating on the front surface of the substrate with the antireflection coating on the back surface and the fringe count of the uncoated front surface of the substrate with no antireflection coating on the back surface. The surface figure reflects a net compressive stress for the beam splitting coating that is expected to produce a convex surface for the beam splitting coating in the optical element. Similarly, the surface figure of the antireflection coating is predicted to be −0.2931 fringes, which reflects a net tensile stress and concave surface for the antireflection coating in the optical element.

Based on the difference in fringe count between the beam splitting coating and the antireflection coating in this example and using Equation (2), it is estimated that inclusion of an SiO₂ layer with a layer stress of 240 MPa and thickness of 595 nm on the back surface of the substrate along with the antireflection coating would balance the stress between the front surface and back surface and minimize wavefront distortion in the optical element of this example. In a preferred configuration, the SiO₂ layer with a layer stress of 240 MPa and thickness of 595 nm is formed directly on the back surface of the substrate and the antireflection coating is formed directly on the SiO₂ layer with a layer stress of 240 MPa and thickness 595 nm.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. An optical element comprising:
a substrate, said substrate having a first surface and a second surface;
a first coating on said first surface, said first coating having a first coating stress and including a first layer, said first layer comprising a first material, said first material having a first layer stress in said first layer;
a second coating on said second surface, said second coating having a second coating stress and including a second layer, said second layer comprising said first material, said first material having a second layer stress in said second layer, said second layer stress being greater in magnitude than said first layer stress.

2. The optical element of claim 1, wherein said first coating is a beam splitting coating.

3. The optical element of claim 2, wherein said second coating is an antireflection coating.

4. The optical element of claim 1, wherein said first material comprises an oxide.

5. The optical element of claim 1, wherein said first layer stress is compressive and said second layer stress is compressive.

6. The optical element of claim 5, wherein said first coating stress is in the range from 75% to 125% of the second coating stress.

7. The optical element of claim 1, wherein said first coating further includes a third layer, said third layer comprising a second material, said second material differing in composition from said first material.

8. The optical element of claim 1, wherein said second coating further includes a third layer, said third layer comprising a second material, said second material differing in composition from said first material.

9. The optical element of claim 8, wherein said second material is a metal fluoride.

10. The optical element of claim 1, wherein said first coating includes a plurality of said first layers.

11. The optical element of claim 10, wherein said first coating further includes a plurality of third layers, each of said third layers comprising a second material, said second material differing in composition from said first material.

12. The optical element of claim 11, wherein said second coating further includes a fourth layer, said fourth layer comprising a third material, said third material differing in composition from said first material.

13. The optical element of claim 12, wherein said first material comprises an oxide and said third material comprises a metal fluoride.

14. An optical element comprising:
a substrate, said substrate having a first surface and a second surface;
a first coating on said first surface, said first coating including a first layer, said first layer comprising a first material, said first material having a first density in said first layer;
a second coating on said second surface, said second coating including a second layer, said second layer comprising said first material, said first material having a second density in said second layer, said second density being greater than said first density.

15. A method of forming an optical element comprising:
forming a first coating on a first surface of a substrate, said first coating having a first coating stress and including a first layer, said first layer including a first material, said first material having a first layer stress in said first layer; and
forming a second coating on a second surface of said substrate, said second coating having a second coating stress and including a second layer, said second layer including said first material, said first material having a second layer stress in said second layer, said second layer stress being greater than said first layer stress.

16. The method of claim 15, wherein said first layer stress is compressive and said second layer stress is compressive.

17. The method of claim 15, further comprising controlling a thickness of said first material in said second layer to offset said first coating stress.

18. The method of claim 15, further comprising controlling said second layer stress to offset said first coating stress.

19. The method of claim 15, wherein said forming first coating further comprises forming a third layer, said third layer including a second material, said second material differing in composition from said first material.

20. The method of claim 19, wherein said forming second coating further comprises forming a fourth layer, said fourth layer comprising a third material, said third material differing in composition from said first material.
